(19) United States
(12) Patent Application Publication
(10) Pub. No.: US 2025/0140938 A1
(43) Pub. Date: May 1, 2025

(54) ZINC BATTERY

(71) Applicant: Energywith Co., Ltd., Tokyo (JP)

(72) Inventor: Kunihiro KUSHIBE, Tokyo (JP)

(21) Appl. No.: 18/682,545

(22) PCT Filed: Sep. 6, 2022
(86) PCT No.: PCT/JP2022/033473

§ 371 Date: Feb. 9, 2024

(30) Foreign Application Priority Data
Sep. 9, 2021 (JP) 2021-146846

(51) Int. Cl. H01M 10/30; H01M 4/02; H01M 4/62; H01M 10/26; H01M 50/44; H01M 50/454

(52) U.S. Cl. CPC H01M 10/30; H01M 4/622; H01M 10/26; H01M 50/44; H01M 50/454; H01M 2004/021

(57) ABSTRACT

Provided is a zinc battery having a positive electrode, a negative electrode, an electrolytic solution, and a separator, in which the negative electrode has a negative electrode current collector and a negative electrode material supported by the negative electrode current collector, the negative electrode material contains a polyvinyl alcohol and a negative electrode active material containing zinc, and the separator has a first separator including a porous membrane and a second separator including a nonwoven fabric.

### TECHNICAL FIELD

The present invention relates to a zinc battery.

### BACKGROUND ART

A nickel-zinc battery, an air-zinc battery, a silver-zinc battery, and the like are known as zinc batteries. For example, it is known that, since the nickel-zinc battery is an aqueous battery using an aqueous electrolytic solution such as a potassium hydroxide aqueous solution, the nickel-zinc battery has high safety and also has a high electromotive force as an aqueous battery by a combination of a zinc electrode and a nickel electrode. Further, since the nickel-zinc battery has excellent input/output performance and is also low in cost, applicability to industrial use applications (for example, use applications such as backup batteries), automotive use applications (for example, use applications such as hybrid vehicles), and the like has been studied.

From the viewpoint of formability of a negative electrode material layer, a cellulose-based compound such as carboxymethyl cellulose may be used as a water-soluble polymer material for a negative electrode material of a zinc battery in some cases, in addition to a negative electrode active material containing zinc (see, for example, Patent Literature 1).

### CITATION LIST

### Patent Literature

Patent Literature 1: Japanese Unexamined Patent Publication No. 2019-160793

### SUMMARY OF INVENTION

### Technical Problem

The zinc battery such as a nickel-zinc battery is required to have further improved life performance. However, the zinc battery using a cellulose-based compound described in Patent Literature 1 has problems in terms of further improvement of life performance and further reduction in direct-current resistance.

An object of an aspect of the present invention is to provide a zinc battery capable of obtaining excellent life performance in the zinc battery and also reducing direct-current resistance.

### Solution to Problem

An aspect of the present invention provides the following zinc battery.
[1] A zinc battery having a positive electrode, a negative electrode, an electrolytic solution, and a separator, in which the negative electrode has a negative electrode current collector and a negative electrode material supported by the negative electrode current collector, the negative electrode material contains a polyvinyl alcohol and a negative electrode active material containing zinc, and the separator has a first separator including a porous membrane and a second separator including a nonwoven fabric.
[2] The zinc battery described in [1], in which the aforementioned negative electrode material contains a metal oxide containing at least one selected from the group consisting of bismuth and indium.
[3] The zinc battery described in [1] or [2], in which the aforementioned negative electrode current collector contains a metal material in which at least a part of a surface is coated by plating with tin.
[4] The zinc battery described in any one of [1] to [3], in which the aforementioned electrolytic solution contains an alkali metal hydroxide.
[5] The zinc battery described in any one of [1] to [4], in which the aforementioned electrolytic solution contains a surfactant.
[6] The zinc battery described in any one of [1] to [5], in which the aforementioned electrolytic solution contains a saccharide.

According to the aforementioned zinc battery, excellent life performance can be obtained in the zinc battery, and direct-current resistance can also be reduced.

### Advantageous Effects of Invention

According to an aspect of the present invention, it is possible to provide a zinc battery capable of obtaining excellent life performance in the zinc battery and also reducing direct-current resistance.

### DESCRIPTION OF EMBODIMENTS

In the present specification, a numerical range that has been indicated by use of “to” indicates the range that includes the numerical values which are described before and after “to”, as the minimum value and the maximum value, respectively. In numerical ranges described stepwise in the present specification, the upper limit value or the lower limit value of a numerical range of a certain stage can be arbitrarily combined with the upper limit value or the lower limit value of a numerical range of another stage. In the numerical ranges that are described in the present specification, the upper limit value or the lower limit value of the numerical range may be replaced with the value shown in experimental examples. “A or B” may include either one of A and B, and may also include both of A and B. Materials listed as examples in the present specification can be used singly or in combinations of two or more kinds, unless otherwise specified. In the present specification, in a case where a plurality of substances corresponding to each component are present in a composition, the used amount of each component in the composition means the total amount of the plurality of substances present in the composition, unless otherwise specified. The term “film” or “layer” in the present specification is meant to include a structure having a shape which is formed over the entire surface when observed in a plan view, as well as a structure having a shape which is formed in a portion. The term “step” in the present specification includes not only an independent step but also a step by which an intended action of the step is achieved, even though the step cannot be clearly distinguished from other steps.

Hereinafter, an embodiment of the present invention will be described in detail. However, the present invention is not limited to the following embodiment and can be modified variously within the scope of the spirit thereof and carried out.

A zinc battery of the present embodiment has at least a positive electrode, a negative electrode, an electrolytic solution, and a separator. In this zinc battery, the negative electrode has a negative electrode current collector and a negative electrode material supported by the negative electrode current collector, and the negative electrode material contains a polyvinyl alcohol and a negative electrode active material containing zinc. The separator has a first separator including a porous membrane and a second separator including a nonwoven fabric.

The zinc battery of the present embodiment is excellent in cycle life performance and has reduced direct-current resistance. Factors for obtaining such an effect include, for example, the following factors, but are not limited to the following factors.

First, although it is known in the conventional zinc battery that a dissolution and deposition reaction of zinc ununiformity progresses with charging and discharging to cause deterioration of the negative electrode such as shape change and internal short-circuit, and the life performance is decreased, it is speculated that, since the zinc battery of the present embodiment contains a polyvinyl alcohol in the negative electrode material, the adhesion between the active materials or between the active material and the current collector is improved by the polyvinyl alcohol, and the dissolution and deposition reaction of zinc is uniformed to obtain excellent life performance.

In addition, as described above, in the conventional zinc battery, the dissolution and deposition reaction of zinc progresses with charging and discharging. This dissolution and deposition reaction of zinc occurs by dissolution of zinc hydroxide (Zn(OH)₂), which is generated by dissolution of zinc in the negative electrode, in the electrolytic solution and diffusion of tetrahydroxy zincate ions ([Zn(OH)₄]²⁻) in the electrolytic solution. However, in the zinc battery of the present embodiment, since the first separator including a porous membrane is included in the separator, this diffusion of tetrahydroxy zincate ions is suppressed. Thereby, it is speculated that deposition of zinc on the negative electrode is suppressed to obtain more excellent life performance. Furthermore, in this zinc battery, since the second separator including a nonwoven fabric is also used as the separator in addition to the first separator including a porous membrane, this nonwoven fabric retains a larger amount of the electrolytic solution. Therefore, the zinc battery of the present embodiment is considered to have excellent performance in terms of reduction in direct-current resistance in addition to excellent life performance.

Examples of the zinc battery include a nickel-zinc battery (for example, a nickel-zinc secondary battery) in which the positive electrode is a nickel electrode; an air-zinc battery (for example, an air-zinc secondary battery) in which the positive electrode is an air electrode; and a silver-zinc battery (for example, a silver-zinc secondary battery) in which the positive electrode is a silver oxide electrode.

Hereinafter, details of the zinc battery of the present embodiment will be described by taking a nickel-zinc battery as an example.

The zinc battery of the present embodiment has at least a positive electrode, a negative electrode (zinc electrode), and a separator. The zinc battery has, for example, a battery container, an electrolytic solution, and an electrode group (for example, an electrode plate group) having a positive electrode, a negative electrode, and a separator. The electrolytic solution and the electrode group are housed in the battery container. The zinc battery may be a battery before or after chemical formation.

In the electrode group, the positive electrode (for example, a positive electrode plate) and the negative electrode (for example, a negative electrode plate) are adjacent to each other with one or a plurality of separators interposed therebetween. That is, one or a plurality of separators are provided between the positive electrode and the negative electrode adjacent to each other. The electrode group may include a plurality of positive electrodes, negative electrodes, and separators. In a case where the electrode group has a plurality of positive electrodes and/or a plurality of negative electrodes, the positive electrodes and the negative electrodes may be alternately laminated with separators interposed therebetween. The plurality of positive electrodes may be connected to each other and the plurality of negative electrodes may be connected to each other, for example, with straps.

In this zinc battery of the present embodiment, the negative electrode has a negative electrode current collector and a negative electrode material supported by the negative electrode current collector, and the negative electrode material contains a polyvinyl alcohol and a negative electrode active material containing zinc. The negative electrode may be an electrode before or after chemical formation.

The negative electrode current collector constitutes an electrical conducting path for current from the negative electrode material. The negative electrode current collector may have, for example, a flat plate shape, a sheet shape, or the like. The negative electrode current collector may be a current collector having a three-dimensional mesh structure made of foamed metal, expanded metal, perforated metal, metal fiber felt, or the like. The negative electrode current collector may be made of a material having electrical conductivity and alkali resistance. As such a material, for example, materials that are stable even at the reaction potential of the negative electrode (such as a material having a nobler oxidation-reduction potential than the reaction potential of the negative electrode and a material that forms a protective film such as an oxide film on a substrate surface in an alkaline aqueous solution and become stabilized) can be used. Furthermore, in the negative electrode, a decomposition reaction of the electrolytic solution progresses as a side reaction to generate hydrogen gas, and a material having a high hydrogen overvoltage is preferable from the viewpoint of suppressing the progress of such a side reaction. Specific examples of the material constituting the negative electrode current collector include metal materials (such as copper, brass, steel, and nickel) in which at least a part of the surface is coated by plating with a metal such as zinc, lead, or tin.

The negative electrode material may be layered, for example. That is, the negative electrode may have a negative electrode material layer. The negative electrode material layer may be formed on the negative electrode current collector. In a case where a portion of the negative electrode current collector that supports the negative electrode material has a three-dimensional mesh structure, the negative electrode material may be filled between the meshes of the current collector to form a negative electrode material layer.

The negative electrode material contains a negative electrode active material (electrode active material) containing zinc. Examples of the negative electrode active material include metallic zinc, zinc oxide, and zinc hydroxide. The negative electrode active material may contain one kind of these components alone or may contain a plurality of kinds thereof. For example, the negative electrode material contains metallic zinc in a fully charged state and contains zinc oxide and zinc hydroxide in a state of the end of discharge. The negative electrode active material may have, for example, a particulate shape. That is, the negative electrode material may contain at least one selected from the group consisting of metallic zinc particles, zinc oxide particles, and zinc hydroxide particles.

The content of the negative electrode active material is preferably in the following range based on the total mass of the negative electrode material. The content of the negative electrode active material is preferably 50% by mass or more, more preferably 70% by mass or more, and further preferably 75% by mass or more, from the viewpoint of easily achieving both of excellent cycle life performance and excellent high-rate discharge performance. The content of the negative electrode active material is preferably 95% by mass or less, more preferably 90% by mass or less, and further preferably 85% by mass or less, from the viewpoint of easily achieving both of excellent cycle life performance and excellent high-rate discharge performance. From these viewpoints, the content of the negative electrode active material is preferably 50 to 95% by mass.

The negative electrode material contains at least a polyvinyl alcohol (hereinafter, sometimes abbreviated as “PVA”) as a binder. The saponification degree of the polyvinyl alcohol is preferably 60% by mol or more, 75% by mol or more, 90% by mol or more, 92% by mol or more, or 96% by mol or more, from the viewpoint of easily obtaining excellent life performance and sufficient adhesion of the negative electrode material with respect to the current collector. The saponification degree of the polyvinyl alcohol is preferably 99.9% by mol or less and more preferably 99% by mol or less, from the viewpoint of easily obtaining excellent life performance and sufficient adhesion of the negative electrode material with respect to the current collector. From these viewpoints, the saponification degree of the polyvinyl alcohol is preferably 60 to 99.9% by mol, 60 to 99% by mol, 75 to 99.9% by mol, 75 to 99% by mol, 90 to 99.9% by mol, 90 to 99% by mol, 92 to 99.9% by mol, 92 to 99% by mol, 96 to 99.9% by mol, or 96 to 99% by mol. Note that, the saponification degree of the polyvinyl alcohol described herein is a value as measured by the method according to JIS K 6726:1994.

The average degree of polymerization of the polyvinyl alcohol is preferably 250 or more, more preferably 500 or more, and further preferably 800 or more, from the viewpoint of easily obtaining excellent life performance and sufficient adhesion of the negative electrode material with respect to the current collector. The average degree of polymerization of the polyvinyl alcohol is preferably 2400 or less, more preferably 1800 or less, and further preferably 1300 or less, from the viewpoint of easily obtaining excellent life performance and sufficient adhesion of the negative electrode material with respect to the current collector. From these viewpoints, the average degree of polymerization of the polyvinyl alcohol is preferably 250 to 2400. Note that, the average degree of polymerization described herein is a value as measured by the method according to JIS K 6726:1994.

The content of the polyvinyl alcohol is preferably 0.1% by mass or more, 0.3% by mass or more, 0.5% by mass or more, or 1% by mass or more, based on the total amount of the negative electrode material, from the viewpoint of easily obtaining excellent life performance and sufficient adhesion of the negative electrode material with respect to the current collector, and the viewpoint of further reducing direct-current resistance. The content of the polyvinyl alcohol is preferably 10% by mass or less, more preferably 5% by mass or less, and further preferably 3% by mass or less, based on the total mass of the negative electrode material, from the viewpoint of securing excellent discharge characteristics. From these viewpoints, the content of the polyvinyl alcohol is preferably 0.1 to 10% by mass, 0.1 to 5% by mass, 0.1 to 3% by mass, 0.3 to 10% by mass, 0.3 to 5% by mass, 0.3 to 3% by mass, 0.5 to 10% by mass, 0.5 to 5% by mass, 0.5 to 3% by mass, 1 to 10% by mass, 1 to 5% by mass, or 1 to 3% by mass, based on the total mass of the negative electrode material. Note that, the above-described content of the polyvinyl alcohol is the content in the negative electrode material after chemical formation, and can be confirmed, for example, by taking the negative electrode out of the zinc battery after chemical formation, performing drying, and then measuring the content of the polyvinyl alcohol in the negative electrode material.

The negative electrode material can further contain a binder other than the polyvinyl alcohol. Examples of the binder include polytetrafluoroethylene, hydroxyethyl cellulose, polyethylene oxide, polyethylene, and polypropylene. The content of the binder may be, for example, 0.5 to 10% by mass with respect to 100% by mass of the negative electrode active material.

The negative electrode material can further contain an additive. Examples of the additive include a dispersant and an electrical conducting material. Examples of the dispersant include polycarboxylic acid (carboxylic acid-based copolymer), polyacrylic acid, polyether, and polymethylsiloxane. The content of the dispersant may be, for example, 0.1 to 1% by mass with respect to 100% by mass of the negative electrode active material.

From the viewpoint that an effect of suppressing self-discharge, an effect of suppressing a decrease in electrolytic solution, or the like is easily obtained and cycle life performance can be further improved and the viewpoint of further reducing direct-current resistance, the negative electrode material may further contain, as an electrical conducting material, at least one metal selected from the group consisting of bismuth (Bi), indium (In), lead (Pb), cadmium (Cd), thallium (TI), and tin (Sn). Among these, at least one selected from the group consisting of bismuth and indium is more preferable. These metals may be contained in the negative electrode material as a metal oxide, and the metal oxide is preferably a metal oxide containing at least one selected from the group consisting of bismuth and indium. That is, the negative electrode material preferably contains at least one selected from the group consisting of bismuth oxide and indium oxide.

The average particle diameter of the electrical conducting material may be less than 0.32 μm, 0.30 μm or less, or 0.25 μm or less, from the viewpoint that cycle life performance and reduction in direct-current resistance are more excellent. The average particle diameter of the electrical conducting material may be 0.02 μm or more, 0.04 μm or more, or 0.06 μm or more, from the viewpoint of handleability in a kneading step. From these viewpoints, the average particle diameter of the electrical conducting material may be 0.02 μm or more and less than 0.32 μm, 0.04 to 0.30 μm, or 0.06 to 0.25 μm. The average particle diameter of the electrical conducting material is a particle diameter as measured by a particle size distribution measuring apparatus (manufactured by NIKKISO CO., LTD., product name: Microtrac HRA9320-X100) and calculated as a median diameter (d50).

The content of the electrical conducting material in the negative electrode material may be 1% by mass or more, 3% by mass or more, or 5% by mass or more, based on the total mass of the electrode material, from the viewpoint that cycle life performance and reduction in direct-current resistance are more excellent. Furthermore, the content of the electrical conducting material may be 50% by mass or less, 30% by mass or less, or 10% by mass or less, from the viewpoint that cycle life performance and reduction in direct-current resistance are more excellent.

From the viewpoint of reducing the degree of solubility of zinc oxide and easily suppressing the shape change of the negative electrode, the negative electrode material may further contain a metal halide such as potassium fluoride, an alkali metal hydroxide such as lithium hydroxide, or a carbonate such as potassium carbonate or sodium carbonate. The content of the metal halide may be, for example, 0.1 to 1% by mass with respect to 100% by mass of the negative electrode active material.

The thickness of the negative electrode is preferably 0.3 to 0.5 mm from the viewpoint of easily achieving both of excellent cycle life performance and excellent high-rate discharge performance. Here, the thickness of the negative electrode means the total thickness of the negative electrode (the thickness after the current collector is filled with the negative electrode material and pressed using a roller or the like to have a predetermined density (for example, the thickness of the negative electrode material layer)).

The positive electrode has, for example, a positive electrode current collector and a positive electrode material supported by the positive electrode current collector. The positive electrode may be an electrode before or after chemical formation.

The positive electrode current collector constitutes an electrical conducting path for current from the positive electrode material. The positive electrode current collector may have, for example, a flat plate shape, a sheet shape, or the like. The positive electrode current collector may be a current collector having a three-dimensional mesh structure made of foamed metal, expanded metal, perforated metal, metal fiber felt, or the like. The positive electrode current collector is made of a material having electrical conductivity and alkali resistance.

As such a material, for example, materials that are stable even at the reaction potential of the positive electrode (such as a material having a nobler oxidation-reduction potential than the reaction potential of the positive electrode and a material that forms a protective film such as an oxide film on a substrate surface in an alkaline aqueous solution and become stabilized) can be used. Furthermore, in the positive electrode, a decomposition reaction of the electrolytic solution progresses as a side reaction to generate oxygen gas, and a material having a high oxygen overvoltage is preferable from the viewpoint of suppressing the progress of such a side reaction. Specific examples of the material constituting the positive electrode current collector include platinum; nickel (such as foamed nickel); and metal materials (such as copper, brass, and steel) plated with metal such as nickel. Among these, a positive electrode current collector made of foamed nickel is preferably used. From the viewpoint that high-rate discharge performance can be further improved, it is preferable that at least a portion (positive electrode material supporting portion) supporting the positive electrode material in the positive electrode current collector is made of foamed nickel.

The positive electrode material may be layered, for example. That is, the positive electrode may have a positive electrode material layer. The positive electrode material layer may be formed on the positive electrode current collector. In a case where a positive electrode material supporting portion of the positive electrode current collector has a three-dimensional mesh structure, the positive electrode material may be filled between the meshes of the current collector to form a positive electrode material layer.

The positive electrode material contains a positive electrode active material (electrode active material) containing nickel. Examples of the positive electrode active material include nickel oxyhydroxide (NiOOH) and nickel hydroxide. For example, the positive electrode material contains nickel oxyhydroxide in a fully charged state and contains nickel hydroxide in a state of the end of discharge. The content of the positive electrode active material may be, for example, 50 to 95% by mass based on the total mass of the positive electrode material.

The positive electrode material may further contain, as an additive, components other than the positive electrode active material. Examples of the additive include a binder, an electrically conductive agent, and an expansion inhibitor.

Examples of the binder include hydrophilic or hydrophobic polymers. Specifically, for example, carboxymethyl cellulose (CMC), hydroxyethyl cellulose (HEC), hydroxypropyl methylcellulose (HPMC), sodium polyacrylate (SPA), a fluorine-based polymer (such as polytetrafluoroethylene (PTFE)), and the like can be used as the binder. The content of the binder is preferably, for example, 0.01 to 5% by mass with respect to 100% by mass of the positive electrode active material.

Examples of the electrically conductive agent include cobalt compounds (such as metallic cobalt, cobalt oxide, and cobalt hydroxide). The content of the electrically conductive agent is preferably, for example, 1 to 20% by mass with respect to 100% by mass of the positive electrode active material.

Examples of the expansion inhibitor include zinc oxide. The content of the expansion inhibitor is preferably, for example, 0.01 to 5% by mass with respect to 100% by mass of the positive electrode active material.

The separator has at least a first separator including a porous membrane and a second separator including a nonwoven fabric. That is, in the zinc battery of the present embodiment, a first separator including at least a porous membrane and a second separator including at least a nonwoven fabric are disposed as a separator between the positive electrode and the negative electrode. The positional relationship between the first separator and the second separator is not particularly limited, and the first separator (porous membrane) may be disposed closer to the positive electrode side than the second separator (nonwoven fabric) (the second separator (nonwoven fabric) may be disposed closer to the negative electrode side than the first separator (porous membrane)), or the nonwoven fabric may be disposed closer to the positive electrode side than the porous membrane (the first separator (porous membrane) may be disposed closer to the negative electrode side than the second separator (nonwoven fabric)). Two or more porous membranes and two or more nonwoven fabrics each may be disposed between the positive electrode and the negative electrode. The separator may further have a third separator made of a material other than the porous membrane and the nonwoven fabric.

The porous membrane in the present specification refers to a membrane having porous property, and has ion permeability while electrically insulating the positive electrode and the negative electrode from each other. A nonwoven fabric (details thereof will be described below) is not included in the porous membrane in the present specification. A porous membrane that satisfies conditions such as having resistance to oxidation on the positive electrode side and resistance to reducing property on the negative electrode side and having alkali resistance can be used as the porous membrane. The porous membrane may have a flat plate shape, a sheet shape, or the like, and may be processed into a bag shape that can house the positive electrode and/or the negative electrode.

The porous membrane may be formed of an organic material such as a resin material, an inorganic material, an organic-inorganic material, or the like. Examples of the organic material include polymers such as polyolefin, nylon, and polyamide. In addition, as a porous membrane formed of an organic material, an oxidation-resistant ion-exchange resin membrane, a cellophane-based recycled resin membrane, and the like can also be used. Examples of the inorganic material include oxides such as alumina, titania, and silicon dioxide; nitrides such as aluminum nitride and silicon nitride; and sulfates such as barium sulfate and calcium sulfate. A porous membrane formed of an inorganic material may be a porous membrane containing particles of these inorganic materials. Examples of the organic-inorganic material include a porous coordination polymer (PCP/MOF).

The porous membrane is preferably a microporous membrane. Specifically, the porous membrane is preferably a porous membrane in which the average pore size and the air permeability of the porous membrane are in the following ranges.

The average pore size of the porous membrane is preferably 20 nm or more, 30 nm or more, or 40 nm or more, from the viewpoint that cycle life performance and reduction in direct-current resistance are more excellent. The average pore size of the porous membrane is preferably 250 nm or less, 200 nm or less, or 150 nm or less, from the viewpoint that cycle life performance and reduction in direct-current resistance are more excellent. From these viewpoints, the average pore size of the porous membrane may be 20 to 250 nm, 20 to 200 nm, 20 to 150 nm, 30 to 250 nm, 30 to 200 nm, 30 to 150 nm, 40 to 250 nm, 40 to 200 nm, or 40 to 150 nm. The average pore size of the porous membrane can be measured by a mercury porosimeter (for example, manufactured by Micromeritics Instrument Corporation, trade name: AutoPore IV 9510).

The air permeability of the porous membrane is preferably 100 sec/100 cc or more, 150 sec/100 cc or more, or 200 sec/100 cc or more, from the viewpoint that cycle life performance and reduction in direct-current resistance are more excellent. The air permeability of the porous membrane is preferably 700 sec/100 cc or less, 600 sec/100 cc or less, or 500 sec/100 cc or less, from the viewpoint that cycle life performance and reduction in direct-current resistance are more excellent. From these viewpoints, the air permeability of the porous membrane may be 100 to 700 sec/100 cc, 100 to 600 sec/100 cc, 100 to 500 sec/100 cc, 150 to 700 sec/100 cc, 150 to 600 sec/100 cc, 150 to 500 sec/100 cc, 200 to 700 sec/100 cc, 200 to 600 sec/100 cc, or 200 to 500 sec/100 cc. The air permeability of the porous membrane can be measured by the method according to JIS P 8117:2009.

The thickness of the porous membrane is preferably 5 μm or more, 10 μm or more, or 15 μm or more, from the viewpoint that cycle life performance and reduction in direct-current resistance are more excellent. The thickness of the porous membrane is preferably 100 μm or less, 75 μm or less, or 50 μm or less, from the viewpoint that cycle life performance and reduction in direct-current resistance are more excellent. From these viewpoints, the thickness of the porous membrane may be 5 to 100 μm, 5 to 75 μm, 5 to 50 μm, 10 to 100 μm, to 75 μm, 10 to 50 μm, 15 to 100 μm, 15 to 75 μm, or 15 to 50 μm. As the thickness of the porous membrane, the average value of thicknesses can be used. For example, five porous membranes of about 10 cm×10 cm are prepared, the thicknesses of any nine points in each porous membrane are measured, and the average value of thicknesses can be used as the thickness of the porous membrane.

From the viewpoint of hydrophilization, the porous membrane may contain an anionic surfactant, a cationic surfactant, an amphoteric surfactant, a nonionic surfactant, or the like, and may be surface-treated by sulfonation treatment, fluorine gas treatment, acrylic acid graft polymerization treatment, corona discharge treatment, plasma treatment, or the like. By performing hydrophilization, the porous membrane is easily brought into contact with an electrolytic solution and a sufficient current density is easily obtained.

The nonwoven fabric may be made of cellulose fibers, aramid fibers, glass fibers, nylon fibers, vinylon fibers, polyester fibers, polyolefin fibers (such as polyethylene fibers or polypropylene fibers), rayon fibers, or the like.

The average pore size of the nonwoven fabric is preferably 0.5 μm or more, 1.0 μm or more, or 2.0 μm or more, from the viewpoint that cycle life performance and reduction in direct-current resistance are more excellent. The average pore size of the nonwoven fabric is preferably 50 μm or less, 40 μm or less, 30 μm or less, or 20 μm, from the viewpoint that cycle life performance and reduction in direct-current resistance are more excellent. From these viewpoints, the average pore size of the nonwoven fabric may be 0.5 to 50 μm, 0.5 to 40 μm, 0.5 to 30 μm, 0.5 to 20 μm, 1.0 to 50 μm, 1.0 to 40 μm, 1.0 to 30 μm, 1.0 to 20 μm, 2.0 to 50 μm, 2.0 to 40 μm, 2.0 to 30 μm, or 2.0 to 20 μm. The measurement method of the average pore size of the nonwoven fabric is the same as the measurement method in the porous membrane described above.

The air permeability of the nonwoven fabric is preferably 0.1 sec/100 cc or more, 0.15 sec/100 cc or more, or 0.2 sec/100 cc or more, from the viewpoint that cycle life performance and reduction in direct-current resistance are more excellent. The air permeability of the nonwoven fabric is preferably 150 sec/100 cc or less, 100 sec/100 cc or less, or 50 sec/100 cc or less, from the viewpoint that cycle life performance and reduction in direct-current resistance are more excellent. From these viewpoints, the air permeability of the nonwoven fabric may be 0.1 to 150 sec/100 cc, 0.1 to 100 sec/100 cc, 0.1 to 50 sec/100 cc, 0.15 to 150 sec/100 cc, 0.15 to 100 sec/100 cc, 0.15 to 50 sec/100 cc, 0.2 to 150 sec/100 cc, 0.2 to 100 sec/100 cc, or 0.2 to 50 sec/100 cc. The measurement method of the air permeability of the nonwoven fabric is the same as the measurement method in the porous membrane described above.

From the viewpoint of further reducing direct-current resistance, the air permeability of the nonwoven fabric is preferably 0.1 sec/100 cc or more, 0.15 sec/100 cc or more, or 0.2 sec/100 cc or more, and is preferably 20 sec/100 cc or less, 10 sec/100 cc or less, or 5 sec/100 cc or less. From the same viewpoint, the air permeability of the nonwoven fabric may be 0.1 to 20 sec/100 cc, 0.1 to 10 sec/100 cc, 0.1 to 5 sec/100 cc, 0.15 to 20 sec/100 cc, 0.15 to 10 sec/100 cc, 0.15 to 5 sec/100 cc, 0.2 to 20 sec/100 cc, 0.2 to 10 sec/100 cc, or 0.2 to 5 sec/100 cc.

The thickness of the nonwoven fabric is preferably 20 μm or more, 30 μm or more, or 40 μm or more, from the viewpoint that cycle life performance and reduction in direct-current resistance are more excellent. The thickness of the nonwoven fabric is preferably 250 μm or less, 200 μm or less, or 150 μm or less, from the viewpoint that cycle life performance and reduction in direct-current resistance are more excellent. From these viewpoints, the thickness of the nonwoven fabric may be 20 to 250 μm, 20 to 200 μm, 20 to 150 μm, 30 to 250 μm, 30 to 200 μm, 30 to 150 μm, 40 to 250 μm, 40 to 200 μm, or 40 to 150 μm. As the thickness of the nonwoven fabric, the average value of thicknesses can be used, and the measurement method is the same as the measurement method in the porous membrane described above.

The electrolytic solution may contain an alkali metal hydroxide, a surfactant, a saccharide, and a solvent. Examples of the solvent include water (for example, ion-exchange water).

The electrolytic solution may contain, for example, potassium phosphate, potassium fluoride, potassium carbonate, sodium phosphate, sodium fluoride, zinc oxide, antimony oxide, titanium dioxide, or the like.

Examples of the alkali metal hydroxide include potassium hydroxide (KOH), sodium hydroxide (NaOH), and lithium hydroxide (LiOH). The alkali metal hydroxide may be ionized (dissociated) in an aqueous solution or may be present as a salt. The alkali metal hydroxide preferably includes at least one selected from the group consisting of potassium hydroxide and lithium hydroxide and more preferably includes potassium hydroxide, from the viewpoint of easily suppressing a decrease in discharge capacity when the zinc battery is stored and the viewpoint of easily obtaining excellent high-rate discharge performance.

The content of the alkali metal hydroxide (the total mass of the alkali metal hydroxide) in the electrolytic solution is preferably in the following range based on the total mass of the electrolytic solution, from the viewpoint of easily suppressing a decrease in discharge capacity when the zinc battery is stored and the viewpoint of easily obtaining excellent high-rate discharge performance. The content of the alkali metal hydroxide is preferably 10% by mass or more, 15% by mass or more, 20% by mass or more, 25% by mass or more, or 30% by mass or more. The content of the alkali metal hydroxide is preferably 50% by mass or less, 45% by mass or less, 40% by mass or less, or 35% by mass or less. From these viewpoints, the content of the alkali metal hydroxide is preferably 10 to 50% by mass.

The content of the potassium hydroxide in the electrolytic solution is preferably in the following range based on the total mass of the electrolytic solution, from the viewpoint of easily suppressing a decrease in discharge capacity when the zinc battery is stored and the viewpoint of easily obtaining excellent high-rate discharge performance. The content of the potassium hydroxide is preferably 10% by mass or more, 15% by mass or more, 20% by mass or more, 25% by mass or more, or 30% by mass or more. The content of the potassium hydroxide is preferably 50% by mass or less, 45% by mass or less, 40% by mass or less, or 35% by mass or less. From these viewpoints, the content of the potassium hydroxide is preferably 10 to 50% by mass.

The content of the lithium hydroxide in the electrolytic solution is preferably in the following range based on the total mass of the electrolytic solution, from the viewpoint of easily suppressing a decrease in discharge capacity when the zinc battery is stored and the viewpoint of easily obtaining excellent high-rate discharge performance. The content of the lithium hydroxide is preferably 0.1% by mass or more, 0.3% by mass or more, 0.5% by mass or more, 0.8% by mass or more, or 1% by mass or more. The content of the lithium hydroxide is preferably 3% by mass or less, 2% by mass or less, 1.5% by mass or less, or 1.2% by mass or less. From these viewpoints, the content of the lithium hydroxide is preferably 0.1 to 3% by mass.

Examples of the surfactant in the electrolytic solution include didodecyldimethylammonium bromide, tetradecyltrimethylammonium bromide, polyoxyethylene decyl ether, and polyoxyalkylene alkyl ether phosphoric acid ester. From the viewpoint of easily obtaining excellent cycle life performance and the viewpoint of easily suppressing a decrease in discharge capacity, the surfactant preferably includes tetradecyltrimethylammonium bromide.

The content of the surfactant (the total mass of the surfactant) in the electrolytic solution is preferably in the following range based on the total mass of the electrolytic solution. The content of the surfactant is preferably 0.001% by mass or more, 0.003% by mass or more, 0.005% by mass or more, or 0.01% by mass or more, from the viewpoint of easily suppressing the deterioration of the discharge performance of the zinc battery. The content of the surfactant is preferably 5% by mass or less, 2.5% by mass or less, 1% by mass or less, 0.7% by mass or less, or 0.5% by mass or less, from the viewpoint of easily obtaining excellent cycle life performance and the viewpoint of easily suppressing a decrease in discharge capacity.

From these viewpoints, the content of the surfactant is preferably 0.001 to 5% by mass. The content of the surfactant is particularly preferably 0.01 to 0.5% by mass from the viewpoint of easily obtaining further excellent cycle life performance and the viewpoint of easily suppressing a decrease in discharge capacity.

As the saccharide, monosaccharides, disaccharides, trisaccharides, polysaccharides (excluding saccharides corresponding to disaccharides or trisaccharides), and the like can be used. Examples of the monosaccharide include glucose, fructose, galactose, arabinose, ribose, mannose, xylose, sorbose, rhamnose, fucose, ribodesose, and hydrates thereof. Examples of the disaccharide include sucrose, maltose, trehalose, cellobiose, gentiobiose, lactose, melibiose, and hydrates thereof. Examples of the trisaccharide include kestose, melezitose, gentianose, raffinose, gentianose, melezitose, and hydrates thereof. Examples of the polysaccharide include cyclodextrin (for example, γ-cyclodextrin) and stachyose.

The content of the saccharide in the electrolytic solution is preferably in the following range based on the total mass of the electrolytic solution. The content of the saccharide is preferably 0.1% by mass or more, 0.3% by mass or more, 0.5% by mass or more, 0.8% by mass or more, or 1% by mass or more, from the viewpoint of easily suppressing a decrease in discharge capacity when the zinc battery is stored and the viewpoint of easily obtaining excellent high-rate discharge performance. The content of the saccharide is preferably 5% by mass or less, 4.5% by mass or less, 4% by mass or less, 3.5% by mass or less, or 3% by mass or less, from the viewpoint of easily suppressing a decrease in discharge capacity when the zinc battery is stored and the viewpoint of easily obtaining excellent high-rate discharge performance. From these viewpoints, the content of the saccharide is preferably 0.1 to 5% by mass.

The content of the saccharide in the electrolytic solution is preferably 1.2% by mass or more, 1.5% by mass or more, 1.8% by mass or more, 2% by mass or more, 2.2% by mass or more, 2.5% by mass or more, 2.7% by mass or more, or 3% by mass or more, from the viewpoint of further easily suppressing a decrease in discharge capacity when the zinc battery is stored. The content of the saccharide may be 3.5% by mass or more, 4% by mass or more, 4.5% by mass or more, or 5% by mass or more. The content of the saccharide is preferably 2.7% by mass or less, 2.5% by mass or less, 2.2% by mass or less, 2% by mass or less, 1.7% by mass or less, 1.5% by mass or less, 1.2% by mass or less, or 1% by mass or less, from the viewpoint of easily obtaining further excellent high-rate discharge performance. From these viewpoints, the content of the saccharide may be 1.2 to 2.7% by mass. The content of the saccharide may be less than 0.5 mol/L based on the total amount of the electrolytic solution.

A method for manufacturing the nickel-zinc battery described above includes, for example, a constituent member manufacturing step of obtaining constituent members of a zinc battery and an assembling step of assembling the constituent members to obtain a zinc battery. In the constituent member manufacturing step, at least electrodes (a positive electrode and a negative electrode) are obtained.

The electrode can be obtained, for example, by adding a solvent (for example, water) to raw materials for electrode materials (a positive electrode material and a negative electrode material) and kneading to obtain an electrode material paste (paste-like electrode material), and then filling the electrode material paste in a current collector to form an electrode material layer.

Examples of the raw material for the positive electrode material include raw materials for a positive electrode active material (for example, nickel hydroxide) and additives (for example, the above-described binder). Examples of the raw material for the negative electrode material include raw materials for a negative electrode active material (for example, metallic zinc, zinc oxide, and zinc hydroxide) and additives (for example, a binder).

Examples of the method for forming an electrode material layer include a method of applying or filling an electrode material paste to or in a current collector and then drying the electrode material paste to obtain an electrode material layer. The density of the electrode material layer may be increased by pressing using a roller, or the like, if necessary.

In the assembling step, for example, the positive electrodes and the negative electrodes obtained in the constituent member manufacturing step are alternately laminated with a separator interposed therebetween, and then the positive electrodes are connected to each other and the negative electrodes are connected to each other with straps to form an electrode group. Next, after this electrode group is housed in a battery container, a cover is attached to the upper surface of the battery container to obtain a chemically unformed zinc battery (nickel-zinc battery).

In the production of the electrode group, as a method of disposing the separator between the positive electrode and the negative electrode, a porous membrane and a nonwoven fabric may be laminated in advance and then disposed between the positive electrode and the negative electrode, or a porous membrane and a nonwoven fabric each may be separately disposed. The separator (the separator having a first separator including a porous membrane and a second separator including a nonwoven fabric) may be disposed between the positive electrode and the negative electrode by respectively housing the positive electrode and the negative electrode in each porous membrane processed into a bag shape and disposing a nonwoven fabric between the positive electrode and the negative electrode.

Subsequently, an electrolytic solution is poured into a battery container of the chemically unformed zinc battery and then left to stand for a certain period of time. Then, a zinc battery (nickel-zinc battery) is obtained by charging under predetermined conditions to chemically forming. The chemical formation conditions can be adjusted according to the properties of the electrode active materials (the positive electrode active material and the negative electrode active material). For example, a nickel-zinc battery after chemical formation can be produced by charging under the conditions of an ambient temperature of 25° C., 32 mA, and 12 hours.

Hereinbefore, the example of the nickel-zinc battery (for example, a nickel-zinc secondary battery) in which the positive electrode is a nickel electrode has been described above, but the zinc battery may be an air-zinc battery (for example, an air-zinc secondary battery) in which the positive electrode is an air electrode, and may be a silver-zinc battery (for example, a silver-zinc secondary battery) in which the positive electrode is a silver oxide electrode.

As the air electrode of the air-zinc battery, a known air electrode used in the air-zinc battery can be used. The air electrode contains, for example, an air electrode catalyst, an electron-conductive material, and the like. As the air electrode catalyst, an air electrode catalyst also functioning as an electron-conductive material can be used.

As the air electrode catalyst, those functioning as a positive electrode in an air-zinc battery can be used, and various air electrode catalysts that can use oxygen as a positive electrode active material can be used. Examples of the air electrode catalyst include carbon-based materials having an oxidation-reduction catalyst function (such as graphite), metal materials having an oxidation-reduction catalyst function (such as platinum and nickel), and inorganic oxide materials having an oxidation-reduction catalyst function (such as perovskite-type oxide, manganese dioxide, nickel oxide, cobalt oxide, and spinel oxide). The shape of the air electrode catalyst is not particularly limited, and may be, for example, a particulate shape. The used amount of the air electrode catalyst in the air electrode may be 5 to 70% by volume, 5 to 60% by volume, or 5 to 50% by volume, with respect to the total volume of the air electrode.

As the electron-conductive material, those having electrical conductivity and enabling electronic conduction between the air electrode catalyst and the separator can be used. Examples of the electron-conductive material include carbon blacks such as ketjen black, acetylene black, channel black, furnace black, lamp black, and thermal black; graphites such as natural graphite like flake graphite, artificial graphite, and expanded graphite; conductive fibers such as carbon fibers and metal fibers; powders of metals such as copper, silver, nickel, and aluminum; organic electron-conductive materials such as a polyphenylene derivative; and any mixtures of these materials. The shape of the electron-conductive material may be a particulate shape, and may be other shapes. The electron-conductive material is preferably used in the form that provides a continuous phase in a thickness direction in the air electrode. For example, the electron-conductive material may be a porous material. Furthermore, the electron-conductive material may be in the form of a mixture or composite with the air electrode catalyst, and as described above, may be an air electrode catalyst also functioning as an electron-conductive material. The used amount of the electron-conductive material in the air electrode may be 10 to 80% by volume, 15 to 80% by volume, or 20 to 80% by volume, with respect to the total volume of the air electrode.

As the silver oxide electrode of the silver-zinc battery, a known silver oxide electrode used in the silver-zinc battery can be used. The silver oxide electrode contains, for example, silver (I) oxide.

### EXAMPLES

Hereinafter, the present invention will be specifically described with reference to Examples. However, the present invention is not limited to the following Examples.

### Example 1

### Production of Negative Electrode

As a negative electrode current collector, a tin-plated steel plate perforated metal having a porosity of 50% was prepared. Next, predetermined amounts of zinc oxide (manufactured by MITSUI MINING & SMELTING CO., LTD., general product), metallic zinc (manufactured by MITSUI MINING & SMELTING CO., LTD., MA-ZB (trade name)), bismuth oxide (manufactured by COREFRONT Corporation, 4115CB (trade name)), indium oxide (manufactured by COREFRONT Corporation, 1710CY (trade name)), polytetrafluoroethylene (PTFE, manufactured by Daikin Industries, Ltd., D210-C (trade name)), polyvinyl alcohol (PVA, saponification degree: 99, manufactured by Kuraray Co., Ltd., POVAL 60-98 (trade name)), and ion-exchange water were added and kneaded to produce a negative electrode material paste. At this time, the amount of water in the negative electrode material paste, which was adjusted to a solid mass ratio of “zinc oxide:metallic zinc:bismuth oxide:indium oxide:PTFE:PVA=69.6:22.8:2.5:1.0:3.0:1.1”, was adjusted to 20% by mass based on the total mass of the negative electrode material paste. Next, the negative electrode material paste was applied to the negative electrode current collector, and then dried at 80° C. for 30 minutes. Thereafter, pressure molding was performed by a roll press to obtain a chemically unformed negative electrode having a negative electrode material (negative electrode material layer).

### Production of Positive Electrode

A grid body made of foamed nickel having a porosity of 95% was prepared, and the grid body was pressure-molded to obtain a positive electrode current collector. Next, predetermined amounts of cobalt-coated nickel hydroxide powder (manufactured by Gold Shine Energy Material Co., Ltd., Y6 (trade name)), metallic cobalt (manufactured by Nikkoshi Co., Ltd., EXTRA FINE (trade name)), cobalt hydroxide (manufactured by ISE CHEMICALS CORPORATION), yttrium oxide (manufactured by FUJIFILM Wako Pure Chemical Corporation, special reagent grade), carboxymethyl cellulose (CMC, manufactured by Changshu Wealthy Science and Technology Co., ltd., BH90-3 (trade name)), polytetrafluoroethylene (PTFE, manufactured by Daikin Industries, Ltd., D210-C (trade name)), and ion-exchange water were added and kneaded to produce a positive electrode material paste. At this time, the solid mass ratio was adjusted to “nickel hydroxide:metallic cobalt:yttrium oxide:cobalt hydroxide:CMC:PTFE=88.0:10.3:1.0:0.3:0.3:0.1”. The amount of water in the positive electrode material paste was adjusted to 27.5% by mass based on the total mass of the positive electrode material paste. Next, the positive electrode material paste was applied to the positive electrode material supporting portion of the positive electrode current collector, and then dried at 80° C. for 30 minutes. Thereafter, pressure molding was performed using a roll press to obtain a chemically unformed positive electrode having a positive electrode material layer.

### Preparation of Separator

For the separator, a porous membrane UP3355 (manufactured by Ube Industries, Ltd., trade name, air permeability: 440 sec/100 mL, average pore size: 80 nm, thickness: 25 μm) was used as the first separator, and a nonwoven fabric (manufactured by NIPPON KODOSHI CORPORATION, trade name: VL-100, air permeability: 0.3 sec/100 mL, average pore size: 9.3 μm, thickness: 100 μm) was used as the second separator. The porous membrane was subjected to hydrophilization treatment with a surfactant Triton-X100 (manufactured by Sigma-Aldrich Japan G.K., trade name) before assembling of a battery. The hydrophilization treatment was performed by a method of immersing the porous membrane in an aqueous solution containing Triton-X100 in an amount of 1% by mass for 24 hours, and then performing drying at room temperature (25° C.) for 1 hour. Note that, the air permeability of the porous membrane indicates a value after the hydrophilization treatment. Further, the porous membrane was cut into a predetermined size, folded in half, and processed into a bag shape by heat-sealing side surfaces with using the folded part as a bottom. The nonwoven fabric cut into a predetermined size was used. Note that, the air permeability described herein is a value as measured by the method according to JIS P 8117:2009.

### <Adjustment of Electrolytic Solution>

Ion-exchange water, potassium hydroxide (KOH), lithium hydroxide (LiOH), tetradecyltrimethylammonium bromide, and sucrose were mixed to prepare an electrolytic solution (with respect to the total mass of the electrolytic solution, potassium hydroxide: 30.0% by mass, lithium hydroxide: 1.0% by mass, tetradecyltrimethylammonium bromide: 0.1% by mass, sucrose: 2.0% by mass, and ion-exchange water: 66.9% by mass).

### Production of Nickel-Zinc Battery

One positive electrode (chemically unformed positive electrode) and one negative electrode (chemically unformed negative electrode) were respectively housed in each porous membrane (first separator) processed into a bag shape. The positive electrode housed in the bag-shaped porous membrane, the negative electrode housed in the bag-shaped porous membrane, and the nonwoven fabric (second separator) were laminated, and then the electrode plates of the same polarity were connected to each other with straps to produce an electrode group (electrode plate group). The electrode group had a configuration in which two positive electrodes and three negative electrodes were included and the nonwoven fabric was disposed one by one between the positive electrode and the negative electrode (between the porous membrane on the positive electrode side and the porous membrane on the negative electrode side). After this electrode group was disposed in a battery container, a cover was attached to the upper surface of the battery container, and the above-described electrolytic solution was poured into the battery container, thereby obtaining a chemically unformed nickel-zinc battery. Thereafter, a nickel-zinc battery having a nominal capacity of 320 mAh was produced by charging under the conditions of an ambient temperature of 25° C., 32 mA, and 12 hours.

### Example 2

A nickel-zinc battery of Example 2 was produced in the same manner as in Example 1, except that bismuth oxide was not used in the negative electrode material paste.

### Example 3

A nickel-zinc battery of Example 3 was produced in the same manner as in Example 1, except that PVA (manufactured by Kuraray Co., Ltd., KURARAY POVAL 60-98 (trade name)) having a saponification degree of 92.5 was used instead of PVA.

### Example 4

A nickel-zinc battery of Example 5 was produced in the same manner as in Example 1, except that the blending amount of each component was adjusted so that the content of PVA was the amount shown in Table 1. Note that, the content shown in Table 1 is the content based on the total mass of the negative electrode material after chemical formation.

### Example 5

A nickel-zinc battery of Example 5 was produced in the same manner as in Example 1, except that the porous membrane was changed to UP3364 (manufactured by Ube Industries, Ltd., trade name, air permeability: 320 sec/100 mL, average pore size: 68 nm, thickness: 20 μm).

### Example 6

A nickel-zinc battery of Example 6 was produced in the same manner as in Example 1, except that the nonwoven fabric was changed to a nonwoven fabric having an air permeability of 144 sec/100 mL, an average pore size of 3.3 μm, and a thickness of 30 μm.

### Comparative Example 1

A nickel-zinc battery of Comparative Example 1 was produced in the same manner as in Example 1, except that the first separator including a porous membrane was not used as the separator (only the second separator including a nonwoven fabric was used).

### Comparative Example 2

A nickel-zinc battery of Comparative Example 1 was produced in the same manner as in Example 1, except that the second separator including a nonwoven fabric was not used as the separator (only the first separator including a porous membrane was used).

### Comparative Example 3

A nickel-zinc battery of Comparative Example 3 was produced in the same manner as in Example 1, except that carboxymethyl cellulose (CMC, manufactured by Changshu Wealthy Science and Technology Co., ltd., BH90-3 (trade name)) was used instead of PVA.

### Comparative Example 4

A nickel-zinc battery of Comparative Example 4 was produced in the same manner as in Example 1, except that hydroxyethyl cellulose (HEC, manufactured by Sumitomo Seika Chemicals Company, Limited., AV-15F (trade name) was used instead of PVA.

### <Evaluation of Cycle Life Performance>

The cycle life performance of the nickel-zinc batteries of Examples 1 to 6 and Comparative Examples 1 to 4 was evaluated. A specific evaluation method is shown below, and the results are shown in Table 2.

A test was performed in which the following operation was taken as one cycle: after the nickel-zinc battery was charged at 105.7 mA (0.33 C) and a constant voltage of 1.88 V in an ambient temperature of 70° C. until the current value was damped to 16 mA (0.05 C), the nickel-zinc battery was discharged at a constant current of 105.7 mA (0.33 C) until the battery voltage reached 1.1 V. The number of cycles in which the discharge capacity was decreased to 70% when the discharge capacity at the first cycle was taken as 100% was regarded as cycle life, and the cycle life performance was evaluated according to evaluation criteria of a to c shown below.
s: The number of cycles is 90 cycles or more.
a: The number of cycles is 60 cycles or more and less than 90 cycles.
b: The number of cycles is 30 cycles or more and less than 60 cycles.
c: The number of cycles is less than 30 cycles.

Note that, the above-described “C” is a relative expression of the magnitude of the current when the rated capacity is discharged at a constant current from a fully charged state. The above-described “C” means “discharge current value (A)/battery capacity (Ah)”. For example, the current at which the rated capacity can be discharged in 1 hour is defined as “1C”, and the current at which the rated capacity can be discharged in 2 hours is defined as “0.5 C”.

### <Evaluation of Direct-Current Resistance>

The direct-current resistance (DCR) of the nickel-zinc batteries of Examples 1 to 6 and Comparative Examples 1 to 4 was evaluated. A specific evaluation method is shown below, and the results are shown in Table 2.

For the nickel-zinc batteries of Examples 1 to 6 and Comparative Examples 1 to 4, after charging was performed at a constant voltage of 1.9 V (charging was terminated when the current value was damped to 16 mA (0.05 C))) in an environment of 25° C., discharging was performed at a constant current with current values of 160 mA (0.5 C), 320 mA (1 C), 640 mA (2C), and 960 mA (3 C) respectively for 1 second in an environment of −30° C., and the direct-current resistance (DCR) per total electrode area was calculated by the following equation. After discharging at a constant current, charging was performed at a constant current of 1 C (current value of 320 mA) in an environment of −30° C. so that the discharge capacity was equal to the charge capacity.

$$DCR = \{ ( Δ {V}_{0.5 C} - V ) ( {I}_{0.5 C} - I ) + ( Δ {V}_{1. C} - V ) ( {I}_{1. C} - I ) + ( Δ {V}_{2. C} - V ) ( {I}_{2. C} - I ) + ( Δ {V}_{3. C} - V ) ( {I}_{3. C} - I ) \} / \{ {( {I}_{0.5 C} - I )}^{2} + {( {I}_{1. C} - I )}^{2} + {( I 2. C - I )}^{2} + {( I 3. C - I )}^{2} \} \cdot AE$$

In the above-described equation, I=(I_{0.5C}+I_{1.0C}+I_{2.0C}+I_{3.0C})/4 and V=ΔV_{0.5C}+ΔV_{1.0C}+ΔV_{2.0C}+ΔV_{3.0C})/4 are satisfied, I_{0.5C}, I_{1.0C}, I_{2.0C}, and I_{3.0C} each represent discharge current values corresponding to a discharge rate 0.5 C, 1.0 C, 2.0 C, and 3.0 C, respectively, and ΔV_{0.5C}, ΔV_{1.0C}, ΔV_{2.0C}, and ΔV_{3.0C} each represent a voltage change after 1 second at each discharge current value. AE indicates the total electrode area.

The DCR determined by the above-described method was evaluated according to evaluation criteria of a to c shown below.
a: The direct-current resistance is less than 10 mΩ·cm².
b: The direct-current resistance is 10 mΩ·cm² or more and less than 11 mΩ·cm².
c: The direct-current resistance is 11 mΩ·cm² or more.

### <Evaluation of Electrode>

The adhesion of the negative electrode was evaluated using the negative electrode produced in each of Examples 1 to 6 and Comparative Examples 1 to 4. A specific evaluation method is shown below, and the results are shown in Table 2.

The negative electrode was naturally dropped to the floor from a height of 1 m, the mass thereof was measured, and an adhesion rate (%) was calculated from the negative electrode masses before the drop test and after the drop test according to the following equation. The adhesion was evaluated according to evaluation criteria of A to C shown below.

$$Adhesion rate ( \% ) = ( Negative electrode mass after drop test / Negative electrode mass before drop test ) \times 100$$

A: The adhesion rate is 95% or more.
B: The adhesion rate is 90% or more and less than 95%.
C: The adhesion rate is less than 90%.

TABLE 1

| | Negative electrode material | | | | |
|---|---|---|---|---|---|
| | Binder | | | | |
| | Material | Saponification | Content | Presence or absence | |
| | name | degree | (% by mass) | of bismuth oxide | Configuration of separator |
| Example 1 | PVA | 99 | 1.1 | Presence | Porous membrane + nonwoven fabric |
| Example 2 | PVA | 99 | 1.1 | Absence | Porous membrane + nonwoven fabric |
| Example 3 | PVA | 92.5 | 1.1 | Presence | Porous membrane + nonwoven fabric |
| Example 4 | PVA | 99 | 0.9 | Presence | Porous membrane + nonwoven fabric |
| Example 5 | PVA | 99 | 1.1 | Presence | Porous membrane + nonwoven fabric |
| | | | | | (type of porous membrane is different |
| | | | | | from that in Example 1) |
| Example 6 | PVA | 99 | 1.1 | Presence | Porous membrane + nonwoven fabric |
| | | | | | (type of nonwoven fabric is different |
| | | | | | from that in Example 1) |
| Comparative | PVA | 99 | 1.1 | Presence | Only nonwoven fabric |
| Example 1 | | | | | |
| Comparative | PVA | 99 | 1.1 | Presence | Only porous membrane |
| Example 2 | | | | | |
| Comparative | CMC | — | 1.1 | Presence | Porous membrane + nonwoven fabric |
| Example 3 | | | | | |
| Comparative | HEC | — | 1.1 | Presence | Porous membrane + nonwoven fabric |
| Example 4 | | | | | |

TABLE 2

Evaluation

| | Cycle life | | Adhesion of negative |
|---|---|---|---|
| | performance | DCR | electrode |
| Example 1 | s | a | A |
| Example 2 | a | b | A |
| Example 3 | a | a | A |
| Example 4 | a | b | A |
| Example 5 | s | b | A |
| Example 6 | a | a | A |
| Comparative | c | a | A |
| Example 1 | | | |
| Comparative | b | c | A |
| Example 2 | | | |
| Comparative | c | c | C |
| Example 3 | | | |
| Comparative | b | c | B |
| Example 4 | | | |

When the zinc batteries of Examples 1 to 6 were compared with the zinc batteries of Comparative Examples 1 to 4, both of cycle life performance and reduction in direct-current resistance were achieved. In addition, Examples 1 to 6 were also superior to Comparative Examples 3 and 4 in the adhesion of the negative electrode. When the zinc batteries of Examples 1 to 6 were compared with Comparative Examples 3 and 4, it is considered that the adhesion between the active materials or between the active material and the current collector was improved by the polyvinyl alcohol, the dissolution and deposition reaction of zinc was uniformed to obtain excellent cycle life performance, and the direct-current resistance was reduced.

1. A zinc battery comprising a positive electrode, a negative electrode, an electrolytic solution, and a separator,
wherein the negative electrode has a negative electrode current collector and a negative electrode material supported by the negative electrode current collector,
the negative electrode material contains a polyvinyl alcohol and a negative electrode active material containing zinc, and
the separator has a first separator including a porous membrane and a second separator including a nonwoven fabric.

2. The zinc battery according to claim 1, wherein the negative electrode material contains a metal oxide containing at least one selected from the group consisting of bismuth and indium.

3. The zinc battery according to claim 1, wherein the negative electrode current collector contains a metal material in which at least a part of a surface is coated by plating with tin.

4. The zinc battery according to claim 1, wherein the electrolytic solution contains an alkali metal hydroxide.

5. The zinc battery according to claim 1, wherein the electrolytic solution contains a surfactant.

6. The zinc battery according to claim 1, wherein the electrolytic solution contains a saccharide.

7. The zinc battery according to claim 1, wherein a saponification degree of the polyvinyl alcohol is 90 to 99.9% by mol.

8. The zinc battery according to claim 1, wherein an average degree of polymerization of the polyvinyl alcohol is 250 to 2400.

9. The zinc battery according to claim 1, wherein a content of the polyvinyl alcohol is 0.1 to 10% by mass based on the total amount of the negative electrode material.

10. The zinc battery according to claim 1, wherein the negative electrode material contains an electrical conducting material.

11. The zinc battery according to claim 10, wherein an average particle diameter of the electrical conducting material is 0.02 μm or more and less than 0.32 μm.

12. The zinc battery according to claim 10, wherein a content of the electrical conducting material in the negative electrode material is 1 to 10% by mass based on the total mass of the negative electrode material.

13. The zinc battery according to claim 1, wherein an average pore size of the porous membrane is 20 to 250 nm.

14. The zinc battery according to claim 1, wherein an air permeability of the porous membrane is 100 to 700 sec/100 cc.

15. The zinc battery according to claim 1, wherein a thickness of the porous membrane is 5 to 100 μm.

16. The zinc battery according to claim 1, wherein an average pore size of the nonwoven fabric is 0.5 to 50 μm.

17. The zinc battery according to claim 1, wherein an air permeability of the nonwoven fabric is 0.1 to 150 sec/100 cc.

18. The zinc battery according to claim 1, wherein a thickness of the nonwoven fabric is 20 to 250 μm.

19. The zinc battery according to claim 4, wherein the alkali metal hydroxide includes at least one selected from the group consisting of potassium hydroxide and lithium hydroxide.

20. The zinc battery according to claim 5, wherein the surfactant includes tetradecyltrimethylammonium bromide.
